(19) United States
(12) Patent Application Publication
(10) Pub. No.: US 2016/0275061 A1
(43) Pub. Date: Sep. 22, 2016

(54) MANAGING THE DISPLAY OF APPLICATION FORMS

(71) Applicant: International Business Machines Corporation, Armonk, NY (US)

(72) Inventors: Xiao Xin Fan, Shanghai (CN); Yuan Jin, Shanghai (CN); Zhen Ni Lv, Shanghai (CN); Li Ping Wang, Shanghai (CN); Wei Jun Zheng, Shanghai (CN)

(21) Appl. No.: 14/661,513

(22) Filed: Mar. 18, 2015

(51) Int. Cl. G06F 17/24; G06F 17/27; G06F 17/22; G06F 17/21

(52) U.S. Cl. CPC G06F 17/243; G06F 17/212; G06F 17/2705; G06F 17/2247

(57) ABSTRACT

A computer implemented method manages display application forms, and receives instructions to display an application on the computer with multiple input fields. Whether each input field is mandatory or optional is determined. Input fields are sorted based whether they are mandatory or optional, and handlers which correspond to the input fields, are displayed based on a variety of display factors.

### BACKGROUND

The present disclosure relates generally to the field of computer systems, and more particularly to managing the display of application forms with multiple input fields.

Improvements in technology have resulted in increased use and reliance on websites displayed on computers and other electronic devices such as mobile devices. Numerous websites require users to register using an application form which in turn requires users to input information in many predetermined input fields which are usually listed vertically. Simultaneous display of all the input fields on one screen is sometimes not possible, especially on small screens. This is inconvenient for users as they are forced to scroll up and down to reach the desired input fields.

### SUMMARY

The present disclosure implements a system, method, and computer program product which manages the display of an application form.

An embodiment of the present disclosure provides a method for managing the display of an application form. The method receives a set of instructions to display an application form, with multiple input fields, on an electronic screen. The method determines whether the input fields are mandatory or optional. The method sorts the input fields based on whether they are mandatory or optional. The method displays a handler comprising of input boxes which correspond to the input fields based on various display factors.

According to another embodiment of the present disclosure a system for managing the display of an application form is provided. The system receives a set of instructions to display an application form, with multiple input fields, on an electronic screen. The system determines whether the input fields are mandatory or optional. The system sorts the input fields based on whether they are mandatory or optional. The system displays a handler comprising of input boxes which correspond to the input fields based on various display factors.

According to a further embodiment of the present disclosure a computer product for managing the display of an application form is provided. The computer product receives a set of instructions to display an application form, with multiple input fields, on a computer screen. The computer product determines whether the input fields are mandatory or optional. The computer product sorts the input fields based on whether they are mandatory or optional. The computer product displays a handler comprising of input boxes which correspond to the input fields based on various display factors.

### BRIEF DESCRIPTION OF THE SEVERAL VIEWS OF THE DRAWINGS

FIG. 1A is schematic block diagram depicting an exemplary computing environment for a managing program, in accordance with an aspect of the present disclosure.

FIG. 1B is as schematic block diagram depicting components of a managing program, in accordance with an aspect of the present disclosure.

FIG. 2 is a flowchart depicting operational steps of a method 200 for a managing program, in accordance with an embodiment of the present disclosure.

FIG. 3A is a schematic block diagram depicting display of an application form with multiple input fields and the, according to an embodiment of the present disclosure.

FIG. 3B is a schematic block diagram depicting display of a handler, in accordance with an embodiment of the present disclosure.

FIG. 3C is a schematic block diagram depicting display of a handler in accordance with an embodiment of the present disclosure.

FIG. 3D is a schematic block diagram depicting display of a handler in accordance with an embodiment of the present disclosure.

FIG. 4 is a block diagram of internal and external components of computers and servers depicted in FIG. 1, according an embodiment of the present disclosure.

### DETAILED DESCRIPTION

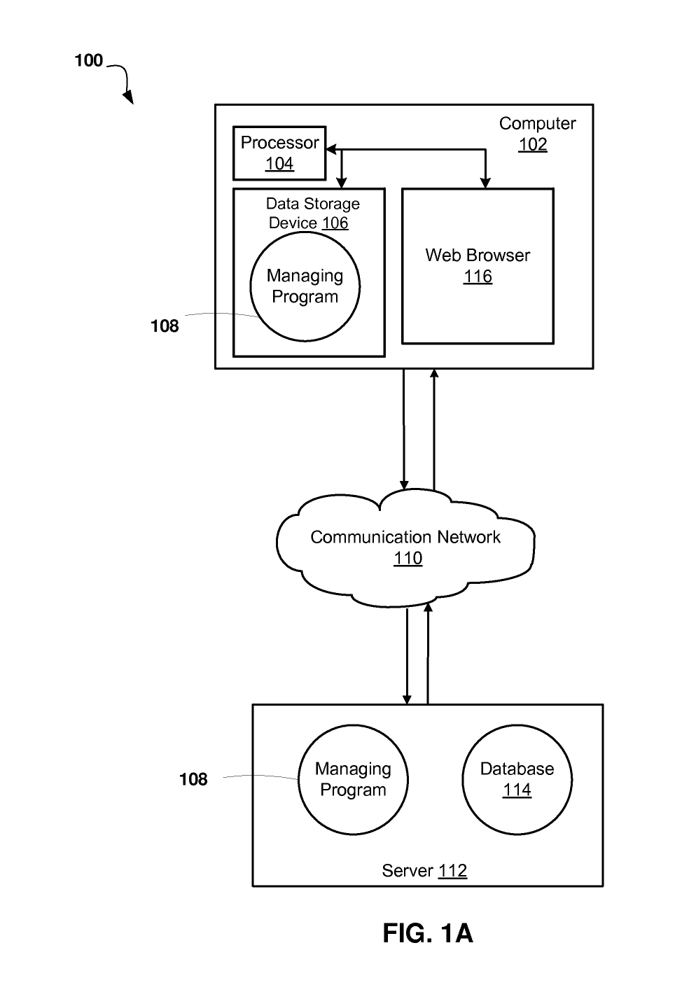

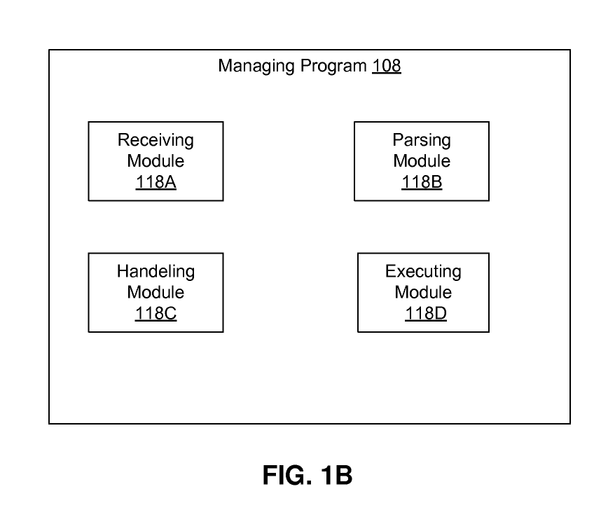

FIG. 1A depicts an exemplary computing environment 100 for managing the display of application forms within a web-based application. In various embodiments of the present disclosure, the environment 100 may include a computer 102 and server 112 connected over communication network 110.

A computer 102 may include a processor 104 and a data storage device 106 that is enabled to run a managing program 108 and a web browser 116 that displays an application form. Non-limiting examples of a web browser may include: Firefox®, Explorer®, or any other web browser. All brand names and/or trademarks used herein are the property of their respective owners.

A networked computer environment 100 may also include a server 112 with a database 114. The server 112 may be enabled to run a program such a managing program 108. A communication network 110 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Communication network 110 may also include a number of different types of networks, such as, for example, an intranet, a local area network (LAN), or a wide area network (WAN).

It should be appreciated that FIG. 1A provides only an illustration of one implementation and does not imply any limitations with regard to the environments in which different embodiments may be implemented. Many modifications to the depicted environments may be made based on design and implementation requirements.

The computer 102 may communicate with the server 112 via the communication network 110. The communication network 110 may include connections, such as wire, wireless communication links, or fiber optic cables.

The computer 102 and the server 112 may be, for example, a mobile device, a telephone, a personal digital assistant, a netbook, a laptop computer, a tablet computer, a desktop computer, or any type of computing device capable of running a program and accessing a network. A program, such as a Managing program 108 may run on the client computer 102 or on the server 112. It should be appreciated that managing program 108 has the same component and operation methods regardless of whether it is run on the server 112 or computer 102. Therefore managing program 108 applies to both a managing program 108 run on a computer 102 and managing program 108 run on the server 112 interchangeably.

Referring now to FIG. 1B, a managing program 108 may include a receiving module 118A, a parsing module 118B, a handling module 118C, and an executing module 118D. The receiving module 118A may receive instructions to display an application form comprising of multiple input fields. The parsing module 118B may parse through the input fields and identify the type of input fields and whether an input field is mandatory or optional. The handling module 118C may further display a handler may comprise of multiple input boxes that correspond to the input fields of the application form. The executing module 118D may receive response instructions on input boxes and execute those instructions on the corresponding application form's input fields. The executing module 118D may further reorder the handler's input boxes based on various modification factors.

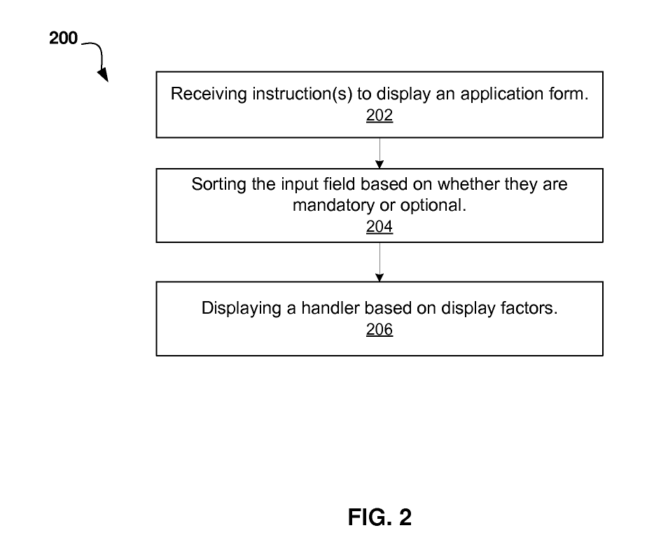

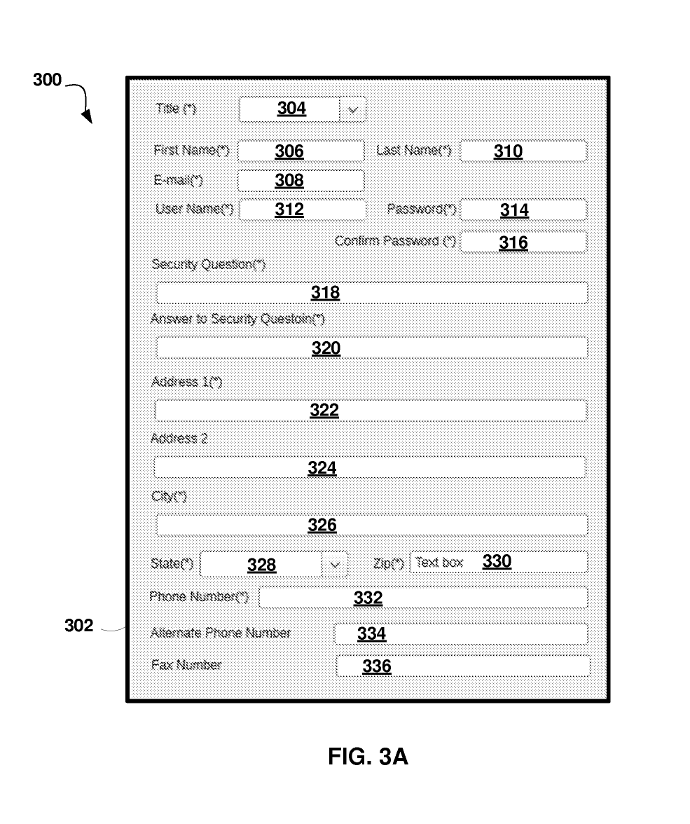

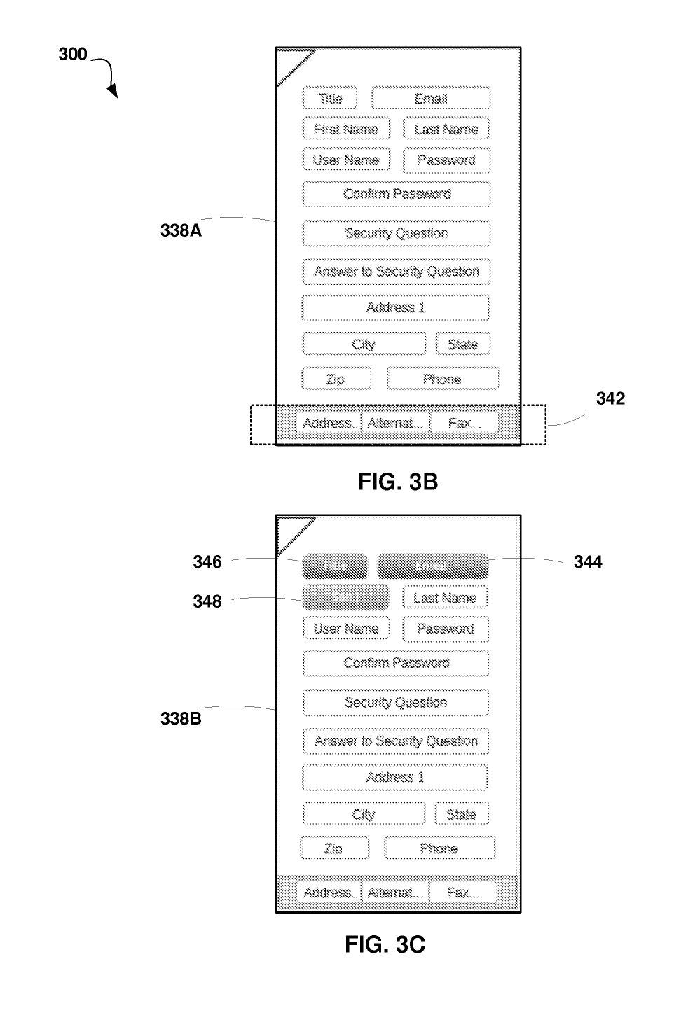

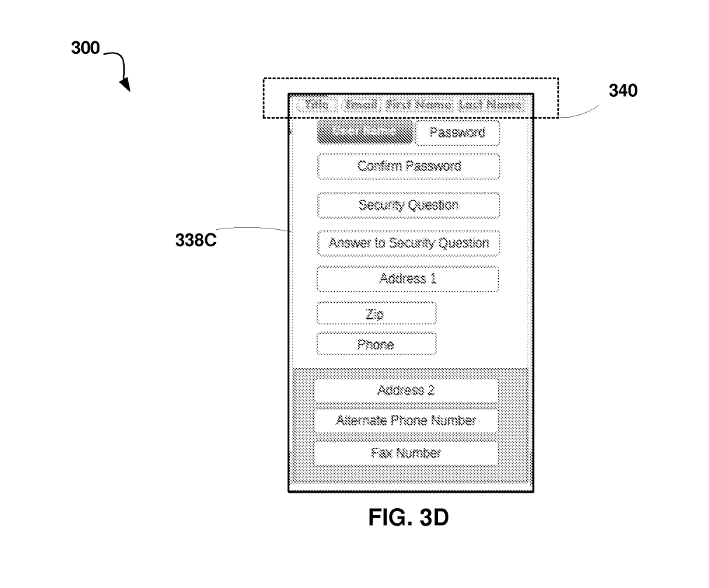

FIG. 2 is flowchart depicting operational steps of a method 200 for a managing program 108, in accordance with an embodiment of the present disclosure. In an embodiment according to the present disclosure, the method 200 includes managing of an application form such as application form 302 illustrated in FIG. 3A. In reference to FIGS. 1A, 1B, and 2, steps of the method 200 may be implemented using one or more modules of a computer program, for example, the managing program 108, and executed by a processor of a computer such as the computer 102.

It should be appreciated that FIG. 2 does not imply any limitations with regard to the environments or embodiments which may be implemented. Many modifications to the depicted environment or embodiment shown in FIG. 2 may be made.

Referring now to block 202, the receiving module 118A may receive a set of instructions from an electronic input source to display an application form with multiple input fields. The receiving module 118A may also receive metadata embedded or associated with the application form. An application form, in this embodiment, is a set of inquiries with predetermined response method. FIG. 3A depicts an embodiment of an application form 302. Embodiments of different response methods may comprise typed-in texts (either limited by character or format or type), and selection from a predetermined list. These different types of response methods (e.g. input fields) are explained below in paragraph 0034.

In this embodiment, receiving module 118A (FIG. 1B) receives instructions from a mobile web browser to display application form 302 (FIG. 3A) on a cell phone screen. The application form 302 comprises sixteen input fields of different types. The receiving module 118A also receives metadata associated with and embedded within the application form 302.

Referring now to block 204, the parsing module 118B sorts, identifies, and parses through input fields of the received application form to identify whether each of the input fields is mandatory or optional. Mandatory input fields are compulsory input fields that the user is required to respond to. An application form is deemed incomplete until and unless all mandatory input fields are responded to. Optional input fields are those input fields that are not mandatory.

In one embodiment, the parsing module 118B may use predetermined values and conditions to identify whether an input field is mandatory or optional. A non-limiting example of a predetermined condition to determine whether the input field is mandatory or optional may be displaying of an asterisk * next to the input field or the title of the input field. Another non-limiting example may be designating a pre-examined category as mandatory. For instance, category of name or date of birth maybe designated as a mandatory input field, and as a result the parsing module 118B may identify all input fields associated with name or date of birth to be mandatory.

In another embodiment, the parsing module 118B may receive predetermined values and conditions from a user or a computer implemented system that may identify whether an input field is mandatory or optional. For example, a user may demand all input fields associated with the title of occupation as optional; as a result, the parsing module 118B may identify occupation input fields as optional.

Furthermore, in another embodiment, the parsing module 118B may also use metadata embedded or associated with the application form or input field to identify whether an input field is mandatory or optional. For example, metadata embedded and associated with an input field may indicate that the input field is mandatory. In an embodiment the parsing module 118B may use HTML to determine whether an input field is mandatory or optional. Hyper Text Markup Language (commonly referred to as HTML) is the standard markup language used to create web pages. It is written in the form of HTML elements consisting of tags enclosed in angle brackets (i.e. <html>). Web browsers can read HTML files and compose them into visible or audible web pages. Browsers do not display the HTML tags and scripts, but use them to interpret the content of the page. HTML describes the structure of a website semantically along with cues for presentation, making it a markup language, rather than a programming language.

In HTML, a required attribute may be used directly. For example, if a required attribute is defined within the code, then a related field is mandatory. The following code may be used by the parsing module 118B to determine whether the user name input fields 306, 310 are mandatory:

<input type=“text” name=“user_name” required=“required” />
In JQuery, if the class name is required, then the related field is mandatory

### Such as:

```
        <div class=“owfield”>
            <span class=“inp”> <input name=“user_name”
class=“required” minlength=“2”> </span>
          </div>
```

In another embodiment, metadata may indicate that an input field becomes mandatory only after a condition is met. For example, an input field may inquire whether the user has been married in the past. If the answer to that inquiry is a yes, then another input field inquiring about the date of the marriage becomes mandatory, and if the answer to the first input field (i.e. whether the user has been married) is no, then the date of marriage is optional.

The parsing module 118B may also use the above-mentioned methods to identify the type of an input field. Non-limiting examples of input field types comprise drop-down, limited, restricted and free input fields. Drop-down input fields are input fields that offer only a predetermined set of answer options to the user. For example, input field 328 (FIG. 3A) inquires the user about the state of the user's residence. The input field 328 offers 50 states within the United States of America as the only options for the user to select from. In one embodiment of this type, within an input field, a predetermined set of answers are offered to the user in a list (commonly known as a “drop-down menu”).

Limited Input fields are defined as input fields which require a response that is within confined limits of a predetermined format. In one embodiment, the predetermined format is defined as the number of digits which a response must have. For instance, input field 330 is a limited input field. The input field 330 inquires about the zip code of the user. The response to this inquiry must have 5 digits. In another embodiment, input field 332, which inquires about the user's phone number, may restrict the user's response to a format of XXX-XXXXXXX (i.e. 10 digits with a dash in between the 3^{rd} and 4^{th} digits).

Restricted input fields are defined as input fields that restrict the number of characters for a response. For example, input field 318 (FIG. 3A) restricts response to the security question to 20 characters or less. Furthermore, free input fields are defined as input fields with no restrictions.

In this embodiment, the parsing module 118B, using the metadata received by the receiving module 118A, identifies and parses through all input fields of the application form 302. The parsing module 118B identifies input fields 304, 306, 308, 310, 312, 314, 316, 318, 320, 322, 326, 328, 330, and 332 as mandatory. The parsing module 118B also identifies input fields 334, 336, and 324 as optional. The parsing module 118B also identifies input fields 304 and 328 as drop-down input fields, input fields 308, 330, 332, 334, and 336 as limited input fields, and the rest of the input fields as free input fields.

Referring now to block 206 (FIG. 2) the handling module 118C may display a handler in lieu of the received application. A handler is a display that comprises a set of input boxes which correspond to the received application. More specifically, each input box of the handler may correspond to an input field from the received application. The input boxes may also correspond to the type of the input field. For example a limited input field may be represented by a limited input box. The handling module 118C may group the input boxes based on whether they are mandatory or optional, and may display input boxes in the handler based on display factors. Display factors are various criteria under which input boxes of a handler may be displayed. Non-limiting examples of a display factor may comprise screen size, type of input fields, number of overall input fields, and ratio of mandatory input fields to optional mandatory input fields. The display factors may be predetermined or may be input by a user or by a computer implemented system. For example, a user may elect to show optional input boxes above mandatory input boxes, a user may elect to view mandatory drop-down input boxes in a different color than the rest of the input boxes, or a user may elect to not view optional input boxes at all.

In this embodiment, the handling module 118C displays the handler 338A depicted in FIG. 3B. The handler 338A comprises of input boxes which correspond to the input fields of the application 302. For example, in this embodiment, input box labeled title displayed by handling module 118C in the handler 338A, corresponds to the input field 304. The handling module 118C, in this embodiment, uses screen size, and the ratio of mandatory input fields to the optional input fields as display factors in order to display handler 338A. The handling module 118C displays a group of mandatory input boxes (which correspond to mandatory input fields) on the top portion of the screen. The handling module 118C displays the optional input boxes (which correspond to the optional input fields) in a group on the bottom of the screen represented by a region 342.

FIGS. 3A-D depict display and operation of a handler instead of an application form according to an embodiment of the present disclosure. According to the present embodiment, an application form is received, parsed, and a handler is displayed, executed, and modified as a user responses to input boxes. Environment 300 illustrates an embodiment of the present disclosure where display of an application form is managed by the managing program 108.

Referring now to FIG. 3A, as explained above and in this embodiment, the receiving module 118A receives instructions to display the application form 302. In this embodiment, the receiving module 118A also receives metadata embedded and/or associated with the application form 302. Furthermore, the parsing module 118B, in this embodiment and as explained above, parses through input fields of the application form 302 and identifies whether each input field is mandatory or optional. In this embodiment, the parsing module 118B, as explained above, also identifies different types of input fields.

Referring now to FIG. 3B, as explained above and in this embodiment, the handling module 118C displays the handler 338A comprising input boxes which correspond to input fields of application form 302 based on display factors (in this embodiment screen size and ratio of mandatory input fields to optional input fields).

Referring now to FIG. 3C, the executing module 118D, in this embodiment, may receive an instruction or a set of instructions to respond to an input box of the handler (i.e. fill out the application). The instruction or set of instructions may be received by the executing module 118D from a user or an implemented computer system. The executing module 118D may also execute the instruction(s) by transferring the response to the corresponding input field of the application form.

Furthermore, the executing module 118D may modify the handler based on modification factors. Modification factors are criteria under which the input boxes of the handler may be displayed after an instruction is executed by the executing module 118D. Non-limiting examples of a modification factor may comprise changing of color, no longer displaying the answered input boxes, grouping the answered input boxes together, or reordering the answered input boxes based a variety of factors such as type of input fields, number of overall un-answered input fields, ratio of mandatory input fields to optional mandatory input fields, ratio of un-answered mandatory input fields to un-answered optional mandatory input field.

Referring now to FIG. 3C the executing module 118D, in this embodiment, may modify the handler 338A to the handler 338B. In this embodiment, the executing module 118D receives instructions to respond to input boxes of title, first name, and Email. The executing module 118D execute the instructions by transferring the responses of input boxes to the corresponding input fields from the application form 302 (i.e. input fields 304, 306, and 308 respectively). The executing module 118D, in this embodiment, changes the color of the responded-to input boxes after executing the instruction (i.e. filling the input fields in application form 302). As depicted in FIG. 3C executing module 118D modifies the colors of input boxes title (input box 346), Email (input box 344) and, first name (input box 348), which have been responded to, in comparison to the rest of the un-responded input boxes (i.e. Last name, Username . . . ).

Referring now to FIG. 3D the executing module 118D, in this embodiment, may modify the handler 338A to handler 338C. In this embodiment, the executing module 118D receives instructions to respond to input boxes of title, first name, last name and Email. The executing module 118D execute the instructions by transferring the responses to the corresponding input fields from application form 302 (i.e. input fields 304, 306, 310 and 308 respectively). The executing module 118D, in this embodiment, then regroups input boxes of the handler 338A using regrouping as a modification factor. In this embodiment, the executing module 118D removes the responded-to input boxes and regroups them in smaller input boxes on top of the screen (e.g. region 340).

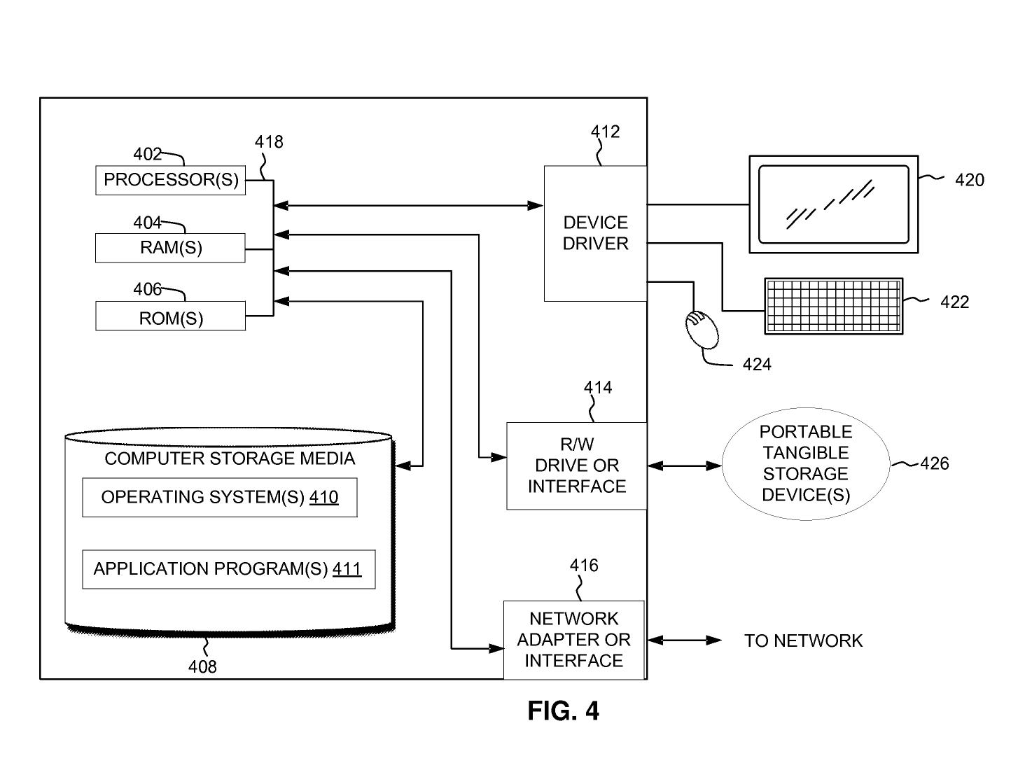

Referring now to FIG. 4 of components a computer system, for example server 112 and data source 120, of distributed data processing environment 100 of FIG. 1, in accordance with an embodiment of the present disclosure.

Server 112 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 112 and computer 102 may also include an R/W drive or interface 414 to read from and write to one or more portable computer readable storage media 426. Application programs 411 on server 112 and computer 102 may be stored on one or more of the portable computer readable storage media 426, read via the respective R/W drive or interface 514 and loaded into the respective computer readable storage media 508.

Server 112 may also include a network adapter or interface 416, such as a TCP/IP adapter card or wireless communication adapter (such as a 4G wireless communication adapter using OFDMA technology). Application programs 411 on server 112 and may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Server 112 and computer 102 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present disclosure. Therefore, the present disclosure has been disclosed by way of example and not limitation.

1. A computer implemented method for managing display of application forms, the method comprising:
receiving a set of instructions on a computer to display an application on the computer, the application including an application form including input fields;
identifying and parsing the input fields based on whether they are mandatory or optional; and
displaying a handler corresponding to the input fields based on one or more display factors, the handler comprises one or more input boxes.

2. The method of claim 1, further comprising:
receiving an instruction to respond to an input box of the one or more input boxes; and
executing the received instruction to respond on corresponding input fields.

3. The method of claim 2, further comprising:
modifying the handler, upon executing the received instruction, based on one or more modification factors.

4. The method of claim 2, further comprising:
removing a responded-to input box from the handler, wherein the responded-to input box comprises an input box for which an instruction to respond is received and executed.

5. The method of claim 2, further comprising:
displaying a responded-to input box in a different color, wherein the responded-to input box comprises an input box for which an instruction to respond is received and executed.

6. The method of claim 1, wherein a type of the input boxes corresponds to the type of the input fields.

7. The method of claim 1, wherein the display factors are based on one or more of:
determining a screen size of a display of the computer;
determining a number of input fields;
determining a type of input fields; and
determining a ratio of mandatory input fields to optional input fields.

8. The method of claim 1, wherein the identifying and parsing the input fields further comprises one or more of:
receiving a set of instructions from a computer implemented system;
receiving metadata associated with the received application form; or
receiving metadata associated with the received input fields.

9. A computer system for managing display of application forms, the computer system comprising:
one or more computer processors;
one or more computer-readable storage media;
program instructions stored on the computer-readable storage media for execution by at least one of the one or more processors, the program instructions comprising:
instructions to receive a set of instructions on a computer to display an application on the computer, the application including an application form including input fields;
instructions to identify and parse the input fields based on whether they are mandatory or optional; and
instructions to display a handler corresponding to the input fields based on one or more display factors, the handler comprises one or more input boxes.

10. The computer system of claim 9, further comprising:
instructions to receive a second set of instructions to respond to an input box of the one or more input boxes; and
instructions to execute the second set of instruction to respond on corresponding input field.

11. The method of claim 10, further comprising:
instructions to modify the handler, upon executing the received instruction, based on one or more modification factors.

12. The method of claim 10, further comprising of instructions to remove a responded-to input box from the handler, wherein the responded-to input box comprises an input box for which an instruction to respond is received and executed.

13. A computer program product for managing display of application forms, comprising a computer-readable storage medium having program code embodied therewith, the program code executable by a processor of a computer to perform a method comprising:
receiving a set of instructions on a computer to display an application on the computer, the application including an application form including input fields;
identifying and parsing the input fields based on whether they are mandatory or optional; and
displaying a handler corresponding to the input fields based on one or more display factors, the handler comprises one or more input boxes.

14. The method of claim 13, further comprising:
receiving an instruction to respond to an input box of the one or more input boxes; and
executing the received instruction to respond on corresponding input fields.

15. The method of claim 14, further comprising:
modifying the handler, upon executing the received instruction, based on one or more modification factors.

16. The method of claim 14, further comprising of removing a responded-to input box from the handler, the responded-to input box comprises an input box for which an instruction to respond is received and executed.

17. The method of claim 14, further comprising of displaying a responded-to input box in a different color, wherein the responded-to input box comprises an input box for which an instruction to respond is received and executed.

18. The method of claim 13, wherein a type of the input boxes corresponds to the type of the input fields.

19. The method of claim 13, wherein the display factors are based on one or more of:
determining a screen size of a display of the computer;
determining a number of input fields;
determining a type of input fields; and
determining a ratio of mandatory input fields to optional input fields.

20. The method of claim 13, wherein the identifying and parsing the input fields further comprises one or more of:
receiving a set of instructions from a computer implemented system;
receiving metadata associated with the received application form; or
receiving metadata associated with the received input fields.
